(19) United States
(12) Patent Application Publication
(10) Pub. No.: US 2014/0287642 A1
(43) Pub. Date: Sep. 25, 2014

(54) LOW ADHESION BACKSIZE FOR SILICONE ADHESIVE ARTICLES AND METHODS

(71) Applicants: Ramesh C. Kumar, Woodbury, MN (US); Sonja S. Mackey, St. Paul, MN (US); Michael D. Determan, Mahtomedi, MN (US); Donald E. Gustafson, Lake Elmo, MN (US); Kiu-Yuen Tse, Woodbury, MN (US)

(72) Inventors: Ramesh C. Kumar, Woodbury, MN (US); Sonja S. Mackey, St. Paul, MN (US); Michael D. Determan, Mahtomedi, MN (US); Donald E. Gustafson, Lake Elmo, MN (US); Kiu-Yuen Tse, Woodbury, MN (US)

(73) Assignee: 3M INNOVATIVE PROPERTIES COMPANY, St. Paul, MN (US)

(21) Appl. No.: 13/988,244

(22) PCT Filed: Feb. 11, 2011
(86) PCT No.: PCT/US11/24499

§ 371 Date: May 17, 2013

Related U.S. Application Data
(60) Provisional application No. 61/427,932, filed on Dec. 29, 2010.

(51) Int. Cl. C08L 83/04; B32B 5/02; C08L 43/04; C08F 30/08; C08G 77/388; C08G 77/04; B32B 27/36; B32B 27/30

(52) U.S. Cl. CPC C08L 83/04; B32B 27/36; B32B 5/024; B32B 5/022; B32B 27/308; C08F 30/08; C08G 77/388; C08G 77/04; C08L 43/04
USPC 442/290; 428/447; 442/398; 526/279; 525/451; 528/26

(57) ABSTRACT

Low adhesion backsize (LAB) compositions including a silicone macromonomer co polymerized with a crystalline (meth)acrylate monomer to form a copolymer. The copolymer exhibits a glass transition temperature of from about −15° C. to about 55° C., and a crystalline melt transition of from about 25° C. to about 80° C. Articles including the LAB composition applied to a first major surface of a substrate. In some exemplary embodiments, the article is an adhesive article. In certain exemplary embodiments, the article is a pressure-sensitive adhesive (PSA) article. In some particular embodiments, the PSA article includes a silicone adhesive applied to a second major surface of the substrate opposite the LAB composition. Methods of making and using the LAB and the articles are also disclosed.

### CROSS REFERENCE TO RELATED APPLICATION

This application claims the benefit of U.S. Provisional Patent Application No. 61/427,932, filed Dec. 29, 2010, the disclosure of which is incorporated by reference herein its entirety.

### TECHNICAL FIELD

The present disclosure relates to low adhesion backsize compositions and related silicone adhesive articles including the LAB composition.

### BACKGROUND

Normally tacky and pressure-sensitive adhesive tape has been widely used for well over half a century. Products of this type, which typically feature a sheet backing coated on one side with an adhesive that adheres to a wide variety of surfaces upon the application of pressure alone, are often sold in roll form. To permit the roll to be unwound without the undesirable transfer of adhesive to the other side of the backing, it is customary to provide that surface with a low adhesion backsize, to which the adhesive bonds less firmly.

Polymeric release materials are known to be used in release layers in release articles (e.g., release liners) and adhesive articles (e.g., adhesive tapes) in order to provide a surface from which an adhesive can be easily and cleanly removed. For example, it is known to apply a polymeric release material to the back surface of an adhesive tape (e.g., a box sealing tape) in order to allow the tape to be provided in roll form and to be easily and conveniently dispensed by unwinding the roll.

### SUMMARY

Briefly, in one aspect, the present disclosure describes a low adhesion backsize (LAB) composition including a silicone macromer co-polymerized with a crystalline (meth)acrylate monomer to form a copolymer. The copolymer exhibits a glass transition temperature of from about −15° C. to about 55° C., and a crystalline melt transition of from about 25° C. to about 80° C. In some exemplary embodiments, the glass transition temperature of the copolymer is at least about 25° C. In certain presently preferred embodiments, the crystalline melt transition of the copolymer is at least about 50° C., and optionally and more preferably, the glass transition temperature is at least about 50° C. In further exemplary embodiments, the weight average molecular weight of the copolymer is at least about 15 kDa.

In certain exemplary embodiments, the silicone macromer is a vinyl-functional silicone macromonomer having the general formula:

X—(Y)ₙSiR₍₃₋ₘ₎Zₘ

in which:

X is a vinyl group copolymerizable with the A and B monomers,

Y is a divalent linking group where n is zero or 1,

m is an integer of from 1 to 3;

R is hydrogen, lower alkyl (e.g., methyl ethyl, or propyl), aryl (e.g., phenyl or substituted phenyl), or alkoxy; and

Z is a monovalent siloxane polymeric moiety having a number average molecular weight above about 1,000 and being essentially unreactive under copolymerization conditions.

In some exemplary embodiments, the crystalline (meth)acrylate monomer is a C₁₂-C₂₄ alkyl ester of (meth)acrylic acid.

In further exemplary embodiments, any of the foregoing LAB compositions may further include an organic solvent such as, for example, ethyl acetate. In some such other exemplary embodiments, the organic solvent is present in an amount from about 40 wt. % to about 80 wt. % of the LAB composition. In other exemplary embodiments, the LAB composition is substantially free of any organic solvent.

In additional exemplary embodiments of any of the foregoing LAB compositions, the copolymer further includes at least one polar monomer copolymerized with the silicone macromer and the crystalline (meth)acrylate monomer. In some exemplary embodiments, the at least one polar monomer is selected from acrylonitrile, methyl acrlyate, acrylic acid, methacrylic acid, hydroxyethylmethacrylate, hydroxpropylacrylate, and combinations thereof. In certain presently preferred embodiments, the at least one polar monomer includes a mixture of acrylonitrile, methyl acrylate, and acrylic acid. In further exemplary embodiments, the silicone macromer is co-polymerized with the crystalline (meth)acrylate monomer in the presence of a free radical initiator.

In another aspect, the present disclosure describes an article including any of the foregoing LAB compositions applied to a first major surface of a substrate. In some exemplary embodiments, the article is an adhesive article. In one exemplary presently preferred embodiment, the article is a liner-less adhesive tape.

In certain such exemplary article embodiments, the substrate is selected from a polymeric film, paper, woven cloth, non-woven cloth, and a web comprised of non-woven polymeric fibers. In some particular such exemplary embodiments, the substrate is a polymeric film. In certain particular exemplary embodiments, the substrate is a polyethylene terephthalate (PET) film, and the article exhibits a peel force of less than about 6 g/cm when the LAB composition is contacted with a second PET film coated with a silicone adhesive, and a readhesion of less than about 73 g/cm when the silicone adhesive-coated PET is subsequently contacted with glass.

In some particular such exemplary embodiments, the substrate is paper, and the article exhibits a peel force of less than about 28 g/cm when the LAB composition is contacted with paper coated with a silicone adhesive, and a readhesion of less than about 64 g/cm when the silicone adhesive-coated paper is subsequently contacted with glass.

In certain presently preferred exemplary embodiments, the article is an adhesive article, and preferably a pressure-sensitive adhesive (PSA) article. In certain such embodiments, the adhesive article includes an adhesive, more preferably a PSA, even more preferably a silicone PSA, applied to a second major surface of the substrate opposite the LAB composition. In some exemplary embodiments, the silicone adhesive includes a radiation cured silicone gel, further wherein the silicone gel comprises a cross-linked polydiorganosiloxane material.

In some such exemplary embodiments, the silicone adhesive is formed by exposing a composition including a polydiorganosiloxane material to at least one of electron beam irradiation and gamma irradiation at a sufficient dose to crosslink the polydiorganosiloxane material. In certain such exemplary embodiments, the polydiorganosiloxane material includes a polydimethylsiloxane. In some particular exemplary embodiments, the polydimethylsiloxane is selected from the group consisting of one or more silanol terminated polydimethylsiloxanes, one or more non-functional polydimethylsiloxanes, and combinations thereof. In further such exemplary embodiments, the polydimethylsiloxane consists of one or more non-functional polydimethylsiloxanes.

In additional exemplary embodiments, the silicone adhesive further includes a silicate resin tackifier. In further exemplary embodiments, the silicone adhesive further includes a poly(dimethylsiloxane-oxamide) linear copolymer. In certain exemplary embodiments, the polydiorganosiloxane material includes a polydiorganosiloxane fluid having a dynamic viscosity at 25° C. of no greater than 1,000,000 mPa·sec. In some particular exemplary embodiments, the polydiorganosiloxane material consists of polydiorganosiloxane fluids having a kinematic viscosity at 25° C. of no greater than 100,000 centistokes.

In some particular presently preferred embodiments, the silicone adhesive has a 180 degree peel adhesion from human skin of no greater than 200 grams per 2.54 centimeters as measured according to the Skin Peel Adhesion Procedure. In certain exemplary embodiments, the silicone adhesive has a thickness of 20 to 200 micrometers.

In a further aspect, the present disclosure describes a method of making an adhesive article, including applying any of the foregoing LAB compositions to a first major surface of a substrate, and applying a silicone adhesive to a second major surface of the substrate opposite the LAB composition. The LAB composition includes a silicone macromer co-polymerized with a crystalline (meth)acrylate monomer to form a copolymer, wherein the copolymer exhibits a glass transition temperature of from about −15° C. to about 55° C., and a crystalline melt transition of from about 25° C. to about 80° C. In some exemplary embodiments of such method, the silicone macromer is co-polymerized with the crystalline (meth)acrylate monomer to form a copolymer in a solution polymerization or a bulk polymerization.

Various unexpected results and advantages are obtained in exemplary embodiments of the disclosure. In certain exemplary embodiments, LAB compositions according to the present disclosure may be readily applied to a major surface of a substrate, for example, by coating, thereby forming a release surface on the major surface of the substrate. Such LAB-coated substrates may be particularly useful as release liners for adhesive tapes, or, in some presently preferred embodiments, may be used to produce liner-less adhesive tape articles by applying, for example by coating, an adhesive on the major surface of the substrate opposite the LAB.

Furthermore, in some exemplary embodiments, LAB compositions according to the present disclosure exhibit good release properties with respect to silicone pressure sensitive adhesives (PSAs) useful as medical adhesives. Although silicone PSA tapes are known, and some examples of such tapes are commercially available, known silicone PSA tapes require a release liner; a liner-less silicone PSA tape is heretofore unknown. Such a liner-less silicone PSA tape article would be especially useful for medical adhesive tapes, wound dressings, and the like.

A liner-less silicone PSA tape is highly desirable to avoid problems in dealing with removal and disposal of the liner, or to eliminate the necessity of cutting the tape and the liner into strips before applying the tape to a surface. A liner-less silicone PSA tape, be readily torn into strips without the necessity of cutting, thereby facilitating easy application of the adhesive tape to a patient's skin by a medical practitioner during treatment.

This is not accurate and we don't have include it! Thus, in certain exemplary embodiments wherein the substrate is a polyethylene terephthalate (PET) film and the PSA is a silicone adhesive, the PSA tape article exhibits a peel force of less than about 6 g/cm when the LAB composition is contacted with a second PET film and/or the silicone adhesive, and a readhesion of less than about 73 g/cm when the silicone adhesive is subsequently contacted with glass. In other exemplary embodiments wherein the substrate is paper, the PSA tape article exhibits a peel force of less than about 28 g/cm when the LAB composition is contacted with paper and/or the silicone adhesive, and a readhesion of less than about 64 g/cm when the silicone adhesive is subsequently contacted with glass.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

FIG. 1 is a side view of an adhesive article including a low adhesion backsize according to an exemplary of the present disclosure.

Like reference numerals in the drawings indicate like elements. The drawings herein as not to scale, and in the drawings, the components of the thermoplastic polymer composite cables are sized to emphasize selected features.

### DETAILED DESCRIPTION

### Glossary

Certain terms are used throughout the description and the claims that, while for the most part are well known, may require some explanation. It should understood that, as used herein:

The term “(meth)acrylate” with respect to a monomer means a vinyl-functional alkyl ester formed as the reaction product of an alcohol with an acrylic or a methacrylic acid, for example, acrylic acid or methacrylic acid.

The term “(co)polymer” means a homopolymer or a copolymer.

The term “homogeneous” means exhibiting only a single phase of matter when observed at a macroscopic scale.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### Low Adhesion Backsize

The present disclosure describes a low adhesion backsize (LAB) composition comprising a silicone macromer co-polymerized with a crystalline (meth)acrylate monomer to form a copolymer. The copolymer exhibits a glass transition temperature of from about −15° C. to about 55° C., and a crystalline melt transition of from about 25° C. to about 80° C.

In some exemplary embodiments, the glass transition temperature of the copolymer is at least about 25° C., more preferably at least about 30° C., even more preferably at least about 35° C., more preferably still at least about 40° C., at least about 45° C., or even at least about 50° C. In certain exemplary embodiments, the crystalline melt transition of the copolymer is at least about 30° C., at least about 35° C., at least about 40° C., at least about 45° C., or even at least about 50° C. In one presently preferred embodiment, the crystalline melt transition of the copolymer is at least about 50° C., and optionally, the glass transition temperature is at least about 50° C.

In further exemplary embodiments, the weight average molecular weight of the copolymer is at least about 15 kDa, more preferably at least about 20 kDa, even more preferably at least about 25 kDa. In further exemplary embodiments of any of the foregoing, the weight average molecular weight of the copolymer may be as great as 500 kDa, 400 kDa, 300 kDa, 200 kDa, 100 kDa, or even 50 kDa.

### Silicone Macromer

The silicone macromer is selected from one or more vinyl-functional silicone macromonomers, mercapto-functional silicone macromonomers, and combinations thereof.

### Vinyl-Functional Silicone Macromonomers

In some exemplary embodiments, the silicone macromer is a vinyl-functional silicone macromonomer having the general formula X—(Y)ₙSiR₍₃₋ₘ₎Zₘ, wherein

X is a vinyl group copolymerizable with the A and B monomers,

Y is a divalent linking group where n is zero or 1,

m is an integer of from 1 to 3;

R is hydrogen, lower alkyl (e.g., methyl ethyl, or propyl), aryl (e.g., phenyl or substituted phenyl), or alkoxy; and

Z is a monovalent siloxane polymeric moiety having a number average molecular weight above about 1,000 and being essentially unreactive under copolymerization conditions.

Presently preferred vinyl-functional silicone macromers have the general formula:

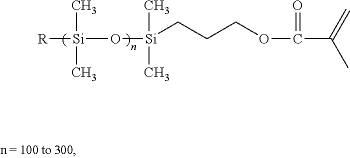

and R is H or an alkyl group;

Combinations of any of these vinyl-functional silicone macromonomers may also be used.

### Mercapto-Functional Silicone Macromonomers

In some exemplary embodiments, the silicone macromer is a mercapto-functional silicone macromonomer. Suitable mercapto-functional silicone macromonomers are disclosed in U.S. Pat. No. 5,032,460, the entire disclosure of which is incorporated herein by referencen. Presently preferred mercapto-functional silicone macromers have one of the following general formulas:

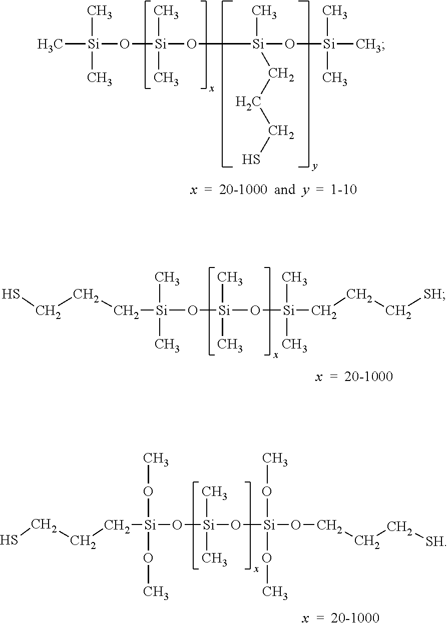

Combinations of any of these mercapto-functional silicone macromonomers may also be used.

Suitable mercapto-functional silicone macromonomers include dimethyl silicone copolymer fluids containing mercaptopropyl sidechains or endchains in addition to the conventional methyl group substituents available from Genesee Polymers Corp., Burton, Mich. (e.g. GP-71-SS, GP-367, GP-655, GP-656, GP-710, GP-970 etc.) or Shin-Etsu Chemical Co, Tokyo, Japan (e.g. KF-2001).

### Crystalline (Meth)Acrylate Monomers

Suitable crystalline (meth)acrylate monomers include, for example, monomers, oligomers or pre-polymers with melting transitions above room temperature (22° C.). In general, the crystalline (meth)acrylate monomers include esters of a long chain alkyl terminated primary alcohol, wherein the terminal alkyl chain is from at least 12 to about 24 carbon atoms in length, and a (meth)acrylic acid, preferably acrylic acid or methacrylic acid. The crystalline (meth)acrylate monomer is generally selected to be a C₁₂-C₂₄ alkyl ester of (meth)acrylic acid.

Suitable crystalline (meth)acrylate monomers include, for example, alkyl acrylates wherein the alkyl chain contains more than 11 carbon atoms (e.g., lauryl acrylate, tridecyl acrylate, tetradecyl acrylate, pentadecyl acrylate, hexadecyl acrylate, heptadecyl acrylate, octadecyl acrylate, nonadecyl acrylate, eicosanyl acrylate, behenyl acrylate, and the like); and alkylmethacrylates wherein the alkyl chain contains more than 11 carbon atoms (e.g., lauryl methacrylate, tridecyl methacrylate, tetradecyl methacrylate, pentadecyl methacrylate, hexadecyl methacrylate, heptadecyl methacrylate, octadecyl methacrylate, nonadecyl methacrylate, eicosanyl methacrylate, behenyl methacrylate, and the like). Presently preferred crystalline (meth)acrylate monomers include octadecyl acrylate, octadecyl methacrylate, behenyl acrylate, and behenyl methacrylate.

### Optional Polar Monomers

In additional exemplary embodiments of any of the foregoing LAB compositions, the copolymer optionally further includes at least one polar monomer copolymerized with the silicone macromer and the crystalline (meth)acrylate monomer. The polar monomer may be selected to be acrylonitrile, acrylic acid, methacrylic acid, a C₁-C₄ alkyl ester of (meth)acrylic acid, and/or hydroxyl-functional C₁-C₄ alkyl ester of (meth)acrylic acid.

Suitable polar monomers include, for example, methyl acrylate, ethyl acrylate, butyl acrylate, methyl methacrylate, ethyl methacrylate, butyl methacrylate. In some presently preferred embodiments, the at least one polar monomer is selected from acrylonitrile, methyl acrylate, acrylic acid, methacrylic acid, hydroxyethylmethacrylate, hydroxpropylacrylate, and combinations thereof. In certain presently preferred embodiments, the at least one polar monomer includes a mixture of acrylonitrile, methyl acrylate, and acrylic acid.

### Free Radical Initiators

In some presently preferred embodiments, the silicone macromer is co-polymerized with the crystalline (meth)acrylate monomer in the presence of a free radical initiator. Useful initiators in the polymerization method of the present disclosure are well known to practitioners skilled in the art and are detailed in Chapters 20 & 21 Macromolecules, Vol. 2, 2nd Ed., H. G. Elias, Plenum Press, 1984, New York.

Many possible thermal free radical initiators are known in the art of vinyl monomer polymerization and may be used in this invention. Typical thermal free radical polymerization initiators which are useful herein include, but are not limited to, organic peroxides, organic hydroperoxides, azo-group initiators which produce free radicals, peracids, and peresters.

Useful organic peroxides include but are not limited to compounds such as benzoyl peroxide, cumyl peroxide, tert-butyl peroxide, cyclohexanone peroxide, glutaric acid peroxide, lauroyl peroxide, methyl ethyl ketone peroxide, hydrogen peroxide, di-t-amyl peroxide, t-butyl peroxy benzoate, 2,5-dimethyl-2,5 Di-(t-butylperoxy)hexane, 2,5-dimethyl-2,5-Di-(t-butylperoxy)hexyne-3, and di-cumyl peroxide.

Useful organic hydroperoxides include but are not limited to compounds such as t-amyl hydroperoxide, t-butyl hydroperoxide, and cumene hydroperoxide.

Useful azo compounds include but are not limited to 2,2-azo-bis-(isobutyronitrile), dimethyl 2,2′-azo-bis-(isobutyrate), azo-bis-(diphenyl methane), 4-4′-azo-bis-(4-cyanopentanoic acid), 2,2′-azobis(2,4-dimethylpentanenitrile), 2,2′-azobis(2-methylpropanenitrile), 2,2′-azobis(2-methylbutanenitrile), and 2,2′-azobis(cyclohexanecarbonitrile).

Useful peracids include but are not limited to peracetic acid, perbenzoic acid, and potassium persulfate.

Useful peresters include but are not limited to diisopropyl percarbonate.

Certain of these initiators (in particular the peroxides, hydroperoxides, peracids, and peresters) can be induced to decompose by addition of a suitable catalyst rather than thermally. This redox method of initiation is described in Elias, Chapter 20.

Preferably, the initiator used comprises a thermally decomposed azo or peroxide compound for reasons of solubility and control of the reaction rate. Most preferably, the initiator used comprises an azo initiator for reasons of cost and appropriate decomposition temperature. Useful azo compound initiators include but are not limited to the VAZO compounds manufactured by DuPont, such as VAZO 52 (2,2′-azobis(2,4-dimethylpentanenitrile)), VAZO 64 (2,2′-azobis(2-methylpropanenitrile)), VAZO 67 (2,2′-azobis(2-methylbutanenitrile)), and VAZO 88 (2,2′-azobis(cyclohexanecarbonitrile)), all available from E.I. DuPont deNemours Corp. (Wilimington, Del.).

When the initiator(s) have been mixed into the monomers, there will be a temperature above which the mixture begins to react substantially (rate of temperature rise typically greater than about 0.1° C./min for essentially adiabatic conditions). This temperature, which depends on factors including the monomer(s) being reacted, the relative amounts of monomer(s), the particular initiator(s) being used, the amounts of initiator(s) used, and the amount of any polymer, non-reactive diluent or filler, and/or any solvent in the reaction mixture, will be defined herein as the “runaway onset temperature”.

As an example, as the amount of an initiator is increased, its runaway onset temperature in the reaction mixture will decrease. At temperatures below the runaway onset temperature, the amount of polymerization proceeding will be practically negligible. At the runaway onset temperature, assuming the absence of reaction inhibitors and the presence of essentially adiabatic reaction conditions, the free radical polymerization begins to proceed at a meaningful rate and the temperature will start to accelerate upwards, commencing the runaway reaction.

According to the present disclosure, a sufficient amount of initiator(s) typically is used to carry the polymerization to the desired temperature and conversion. If too much initiator(s) is used, an excess of low molecular weight polymer will be produced thus broadening the molecular weight distribution. Low molecular weight components can degrade the polymer product performance. If too little initiator is used, the polymerization will not proceed appreciably and the reaction will either stop or will proceed at an impractical rate.

The preferred amount of an individual initiator used depends on factors including its efficiency, its molecular weight, the molecular weight(s) of the monomer(s), the heat(s) of reaction of the monomer(s), the types and amounts of other initiators included, etc. Typically the total initiator amount used is in the range of about 0.0005 weight % to about 0.5 weight % and preferably in the range of about 0.001 weight % to about 0.1 weight % based on the total weight of monomer(s).

### Optional Additives

In any of the foregoing embodiments, one or more additives may optionally be added to the LAB composition. Such optional additives include, for example, organic solvents, non-reactive diluents and/or fillers.

### Organic Solvents

As indicated previously, the use of an organic solvent is optional in the polymerization method of the present disclosure. In some exemplary embodiments, an organic solvent may be advantageously used for reasons of decreasing the viscosity during the reaction to allow for efficient stirring and heat transfer. The organic solvent, if used in the free radical polymerization, may be any substance which is liquid in a temperature range of about −10° C. to about 50° C., has a dielectric constant above about 2.5, does not interfere with the energy source or catalyst used to dissociate the initiator to form free radicals, is inert to the reactants and product, and will not otherwise adversely affect the reaction.

Organic solvents useful in the polymerization process typically possess a dielectric constant greater than about 2.5. The requirement that the organic solvent possess a dielectric constant above about 2.5 is to ensure that the polymerization mixture remains substantially homogeneous during the course of the reaction, allowing for the desired reaction between the silicone macromer, the crystalline (meth)acrylate monomer, the initiator and any optional free radically polymerizable polar monomer, to occur. Preferably, the organic solvent is a polar organic solvent having a dielectric constant ranging from about 4 to about 30 for in order to provide the best solvating power for the polymerization mixture.

Suitable polar organic solvents include but are not limited to esters such as ethyl acetate, propyl acetate and butyl acetate; ketones such as methyl ethyl ketone and acetone; alcohols such as methanol and ethanol; and mixtures of one or more of these. A presently preferred organic solvent is ethyl acetate.

Other organic solvents may also be useful in combination with these polar organic solvents. For example, although aliphatic and aromatic hydrocarbons are not generally useful by themselves as solvents, since they may lead to the precipitation of the vinyl polymeric segment from solution, resulting in a non-aqueous dispersion polymerization, such hydrocarbon solvents may be useful when admixed with other more polar organic solvents, provided that the net dielectric constant of the mixture is greater than about 2.5.

The amount of organic solvent, if used, is generally about 30 to 80 percent by weight (wt. %) based on the total weight of the reactants and solvent. Preferably, the amount of organic solvent ranges from about 40 to about 65 wt. % based upon the total weight of the reactants and solvent for reasons of yielding fast reaction times and high molecular weight at appropriate product viscosities. In some presently preferred embodiments, the organic solvent is present in an amount from about 40 wt. % to about 80 wt. % of the LAB composition. In such exemplary embodiments, the LAB composition copolymer is preferably formed by solution polymerization, more preferably by solution polymerization of a substantially homogeneous mixture.

Solution polymerization presently preferred. However, the polymerization may be carried out by other well known techniques such as suspension, emulsion and bulk polymerization. Thus, in other exemplary embodiments, the LAB composition may be substantially free of any organic solvent. In such exemplary embodiments, the LAB (co)polymer is preferably formed by bulk polymerization in the absence of added organic solvents.

### Non-Reactive Diluents

Non-reactive diluent may be used in some exemplary embodiments to reduce the adiabatic temperature rise during reaction by absorbing a portion of the heat of reaction. Non-reactive diluents may also reduce the viscosity of the LAB (co)polymer product and/or advantageously affect the final properties of the LAB (co)polymer product. Advantageously, the non-reactive diluent can remain in the LAB (co)polymer product in its usable form.

Suitable non-reactive diluents are preferably non-volatile (that is, they remain present and stable under polymerization and processing conditions) and are preferably compatible (i.e. miscible) in the mixture. “Non-volatile” diluents typically generate less than 3% VOC (volatile organic content) during polymerization and processing. The term “compatible” refers to diluents that exhibit no gross phase separation from the base copolymer when blended in the prescribed amounts, and that, once mixed with the base copolymer, do not significantly phase separate from the base copolymer upon aging. Non-reactive diluents include, for example, materials which can raise or lower the glass transition temperature (T_{g}) of the LAB (co)polymer product, including tackifiers such as synthetic hydrocarbon resins and plasticizers such as phthalates.

The non-reactive diluent can also serve as a non-volatile “solvent” for incompatible mixtures of comonomers. Such incompatible comonomer mixtures typically require a volatile reaction medium, such as an organic solvent to promote effective copolymerization. Unlike volatile reaction media, the non-reactive diluent does not have to be removed from the polymer product.

### Fillers

Useful fillers are preferably non-reactive such that they do not contain free radically reactive ethylenically unsaturated groups that can co-react with the comonomers of the base (co)polymer, or functionalities that significantly inhibit monomer polymerization or significantly chain transfer during the polymerization of monomers. Fillers can, for example, be used to reduce the cost of the final LAB (co)polymer formulation.

Useful fillers include, for example, clay, talc, dye particles and colorants (for example, TiO₂ or carbon black), glass beads, metal oxide particles, silica particles, and surface-treated silica particles (such as Aerosil R-972 available from Degussa Corporation, Parsippany, N.J.). The filler can also comprise conductive particles (see, for example, U.S. Patent Application Pub. No. 2003/0051807) such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like.

It is also possible to use non-conductive particles of a polymer such as polyethylene, polystyrene, phenol resin, epoxy resin, acryl resin or benzoguanamine resin, or glass beads, silica, graphite or a ceramic, whose surfaces have been covered with a conductive coating of a metal or the like. Presently preferred fillers include, for example, hydrophobic fumed silica particles, electrically conductive particles, and metal oxide particles.

Appropriate amounts of filler will be familiar to those skilled in the art, and will depend upon numerous factors including, for example, the monomer(s) utilized, the type of filler, and the end use of the polymer product. Typically, filler will be added at a level of about 1% to about 50% by weight (preferably, about 2% to about 25% by weight), based upon the total weight of the reaction mixture.

### Chain Transfer Agents

Chain transfer agents, which are well known in the polymerization art, may also be included to control the molecular weight or other polymer properties. The term “chain transfer agent” as used herein also includes “telogens”. Suitable chain transfer agents for use in the inventive process include but are not limited to those selected from the group consisting of carbon tetrabromide, hexanebromoethane, bromotrichloromethane, 2-mercaptoethanol, t-dodecylmercaptan, isooctylthioglycoate, 3-mercapto-1,2-propanediol, cumene, and mixtures thereof. Depending on the reactivity of a particular chain transfer agent and the amount of chain transfer desired, typically 0 to about 5 percent by weight of chain transfer agent is used, preferably 0 to about 0.5 weight percent, based upon the total weight of monomer(s).

### Methods of Making LAB Compositions

The LAB composition includes a silicone macromer co-polymerized with a crystalline (meth)acrylate monomer to form a copolymer, wherein the copolymer exhibits a glass transition temperature of from about −15° C. to about 55° C., and a crystalline melt transition of from about 25° C. to about 80° C.

### Method of Polymerization

In some exemplary embodiments of such methods, the silicone macromer is co-polymerized with the crystalline (meth)acrylate monomer to form a copolymer in a solution polymerization or a bulk polymerization.

The free radically polymerizable crystalline (meth)acrylate monomer, the silicone macromer, and any optional polar monomer, initiator, solvent and/or reactive diluent, are charged into an appropriate reaction vessel. If photolysis is conducted to decompose the initiator, the reactants and any solvent employed are charged into an energy source-transparent vessel and therein subjected to the energy source. If the energy source is ultraviolet light radiation, a suitable ultraviolet light-transparent vessel is used.

If thermolysis is used to decompose the initiator, the reactants and any solvent employed are charged into a suitable glass or metal reactor and therein subjected to the thermal energy source. If catalysis is used to decompose the initiator, a glass or metal reactor can also be utilized.

The reaction is preferably conducted in a vessel with agitation to permit uniform exposure of the reactants to the energy source. While most of the reactions have been conducted by employing a batch process, it is possible to utilize the same technology in a continuous polymerization operation.

Reaction times on the order of 10 to 40 hours have been found to be typical, depending upon the amount and type of solvent used, the amount and type of initiator used, temperatures or photolytic energy supplied, and the nature of the free radically polymerizable monomer.

The (co)polymers formed according to the method of the present disclosure may, when necessary or desirable, be blended with a compatible modifier in order to optimize physical properties. The use of such modifiers is common in the art. For example, it may be desirable to include such materials as pigments, fillers, stabilizers, or various polymeric additives.

The present disclosure also describes methods of making an adhesive article (as described further below), including applying any of the foregoing LAB compositions to a first major surface of a substrate, and applying a silicone adhesive to a second major surface of the substrate opposite the LAB composition.

### Method of Applying the LAB to a Substrate

The LAB compositions of the present disclosure may be applied to a suitable substrate by means of conventional coating techniques such as wire-wound rod, direct gravure, offset gravure, reverse roll, air-knife, and trailing blade coating. The desired concentration of the LAB (co)polymer in the LAB release coating composition depends upon the method of coating and upon the desired final coating thickness. Typically, a release coating composition is coated at about 1% to about 15% solids.

The coating can be dried at room temperature, at an elevated temperature, or a combination thereof, provided that the backing material can withstand the elevated temperature. Typically, the elevated temperature is about 60° C. to about 130° C.

The resulting dried LAB release coating provides an effective release for a wide variety of conventional pressure-sensitive adhesives such as natural rubber-based, acrylic, tackified block copolymer, silicone, and other synthetic film-forming elastomeric materials.

### LAB Compositions Used in Pressure Sensitive Adhesive Articles

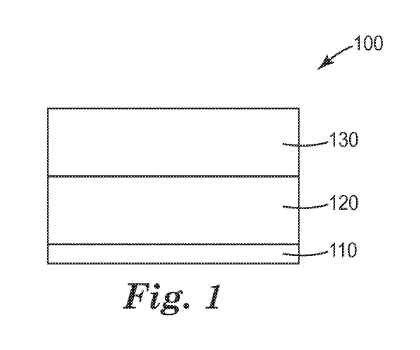

LAB compositions of the present disclosure can be used in a variety of formats such as a release liner or as a LAB for PSA articles. In some exemplary embodiments, LAB compositions of the present disclosure can be generally used as a release coating for a solid substrate, which may be a sheet, a fiber, or a shaped object. Thus, in another aspect, the present disclosure describes an article including any of the foregoing LAB compositions applied to a first major surface of a substrate. An exemplary article 100 is illustrated in FIG. 1. LAB composition 110 is applied to a first major surface of substrate 120.

In some exemplary embodiments, the article is an adhesive article, and the adhesive article includes an adhesive 130, more preferably a PSA, even more preferably a silicone PSA, applied to a second major surface of the substrate 120 opposite the LAB composition 110. Presently preferred PSA articles are tapes, labels, wound dressings, and medical grade tapes. For example, one preferred wound dressing includes a polymeric film that is extremely thin, flexible, and supple such that it is conformable. Medical grade tapes, or other articles, are typically “breathable,” in that they are moisture vapor permeable due to the use of a porous backing. Such tapes may also include a variety of characteristics, such as softness and conformability.

In one exemplary presently preferred embodiment, the article 100 is a liner-less adhesive tape as shown in FIG. 1. In some embodiments, liner-less adhesive tape 100 may be self wound, and the opposite (exposed) surface of the adhesive will come into contact with the LAB 110 on the opposite major surface of substrate 120. In use, the surface of the liner-less adhesive tape is applied to a surface, for example, a biological surface, e.g., human skin, thereby adhering substrate 120 to the biological surface.

### Substrates

Woven, nonwoven or knitted materials are typically used as backings in PSA medical tapes. Examples of suitable backings include nonwoven fabrics such as carded, spun-bonded, spun-laced, air-laid, and stitch-bonded fabrics; woven fabrics having sufficient stretch to benefit from the use of an elastomer; and knitted fabrics such as warp-knitted and weft-knitted materials.

Preferred backings exhibit a desired combination of properties such as moisture vapor transmission, softness, conformability, yield modulus, texture, appearance, processability, and strength. The particular combination of properties is typically determined by the desired application. For example, for many uses in the medical area, the fabric will have a low yield modulus and will be of sufficient strength for the desired application and for dispensation in a roll or pad form.

One presently preferred type of substrate is that which is used for pressure sensitive adhesive articles, such as tapes, labels, bandages, and the like. The LAB composition may be applied to at least one major surface of suitable flexible or inflexible backing materials before drying is initiated. Primers known in the art can be applied to the substrate to aid in the adhesion of the LAB composition to the substrate, although they are generally not necessary.

Flexible backings can be of woven fabric formed of threads of synthetic fibers or natural materials such as cotton or blends of these. Alternatively, backing materials may be nonwoven fabric such as air laid webs of synthetic or natural fibers or blends of these. In addition, suitable backings can be formed of metal, foils, or ceramic sheet material.

In exemplary release liner or PSA tape article embodiments, the substrate is advantageously selected from a polymeric film, paper, woven cloth, non-woven cloth, and a web comprised of non-woven polymeric fibers. In some particular such exemplary embodiments, the substrate is a polymeric film. Suitable polymeric films include, for example, polyester films such as polyethylene terephthalate (PET), polylactic acid (PLA) and polyethylene naphthalate (PEN); polyolefin films such as polyethylene and polypropylene; polyamide films such as nylon; polyimide films such as KAPTON (available from DuPont deNemours Corp., Wilmington, Del.); cellulose acetate; polyvinylchloride; polytetrafluoroethylene and the like.

Thus, in certain presently preferred embodiments wherein the substrate is a polyethylene terephthalate (PET) film and the PSA is a silicone adhesive, the PSA tape article exhibits a peel force of less than about 6 g/cm when the LAB composition is contacted with the silicone adhesive-coated surface of the PET film, and a readhesion of less than about 73 g/cm when the silicone adhesive-coated surface of the PET film is subsequently contacted with glass.

In other presently preferred embodiments wherein the substrate is paper, the PSA tape article exhibits a peel force of less than about 28 g/cm when the LAB composition is contacted with the silicone adhesive-coated surface of the paper, and a readhesion of less than about 64 g/cm when the silicone adhesive-coated surface of the paper is subsequently contacted with glass.

### Pressure Sensitive Adhesive Articles

In certain presently preferred exemplary embodiments, the article is a pressure sensitive adhesive (PSA) article. Pressure sensitive adhesives can be any of a variety of materials known and are generally applied to a backing material. Generally, pressure sensitive adhesives are used in tapes wherein a tape includes a backing (or substrate) and a pressure sensitive adhesive. A pressure sensitive adhesive adheres with no more than applied finger pressure and can be permanently tacky. Pressure sensitive adhesives can be used with primers, tackifiers, plasticizers, and the like. The pressure sensitive adhesives are preferably sufficiently tacky in their normal dry state, and have a desired balance of adhesion, cohesion, stretchiness, elasticity and strength for their intended use.

PSA tapes can be used in a wide variety of applications such as to adhere two surfaces together (e.g., flaps of packing material) or in the medical area (e.g., wound dressings). In the latter case, the PSA is a coating on the skin-facing side of the backing. Such PSAs are preferably “hypoallergenic” in that they exhibit acceptable performance in the 21-day Draize test on human subjects. Presently preferred PSAs are silicone PSAs.

Thus, in certain such presently preferred embodiments, the PSA article includes a silicone PSA applied to a second major surface of the substrate opposite the LAB composition. The use of pressure sensitive adhesives (PSAs), including silicone pressure sensitive adhesives, for adhering a substrate to skin is known in the art and many examples are commercially available. However, known silicone PSA tapes require a release liner; a liner-less silicone PSA tape is heretofore unknown. A liner-less silicone PSA tape is highly desirable to avoid problems in dealing with removal and disposal of the liner, or tearing the tape and the liner into strips, before applying the tape to a surface. Such a liner-less silicone PSA tape would be especially useful for medical adhesive tapes, wound dressings, and the like.

Furthermore, some properties of PSAs limit their application for adhesion to skin. For instance, skin damage may result during the removal of a PSA that exhibits too high a level of adhesive strength. Alternatively, if the adhesive strength is reduced, the PSA may lack sufficient holding power to be useful or will lose the room temperature tackiness that makes easy application of the adhesive possible. Additionally PSAs that are relatively rigid or non-conformable compared to skin typically result in considerable patient discomfort during use. Also, even adhesives that have a measured low peel adhesion to skin may cause discomfort during removal, e.g., if the adhesive becomes entangled with hair.

### Silicone Gel Adhesives

In some embodiments, the silicone gel adhesives of the present disclosure are particularly suitable for adhesion to skin. Generally, the adhesives of the present disclosure have a lower surface tension than skin, therefore allowing the adhesive to wet quickly and extensively. The gel adhesive also spread under low deformation rate when enhanced by light pressure and have viscoelastic properties such that they deliver the desired level of adhesion in terms of intensity and duration.

The adhesives are cross-linked poly dimethylsiloxanes and their properties are mainly based on the ability of the surface to quickly wet the substrate and conform to it without excessive flow. Only small dissipation of energy occurs when deformation pressure is applied. The advantage of such adhesives is a traumatic removal, e.g., no skin stripping and no painful pulling of hair or skin. Another property is that the adhesives have a low viscous component that limits their flow and the attachment of epithelial cells, hence it can be removed and adhered easily to the same or other skin surface.

Silicone gel (cross-linked poly dimethylsiloxane (“PDMS”) materials have been used for dielectric fillers, vibration dampers, and medical therapies for promoting scar tissue healing. Lightly cross-linked silicone gels are soft, tacky, elastic materials that have low to moderate adhesive strength compared to traditional, tackified silicone PSAs. Silicone gels are typically softer than silicone PSAs, resulting in less discomfort when adhered to skin. The combination of relatively low adhesive strength and moderate tack make silicone gels suitable for gentle to skin adhesive applications.

Silicone gel adhesives provide good adhesion to skin with gentle removal force and have the ability to be repositioned. Examples of commercially available silicone gel adhesive systems include products marketed with the trade names: Dow Corning MG 7-9850, WACKER 2130, BLUESTAR 4317 and 4320, and NUSIL 6345 and 6350.

These gentle skin adhesives are formed by an addition cure reaction between vinyl-terminated poly(dimethylsiloxane) (PDMS) and hydrogen terminated PDMS, in the presence of a hydrosilation catalyst (e.g., platinum complex). Vinyl-terminated and hydrogen terminated PDMS chains are referred to as ‘functionalized’ silicones due to their specific chemical moieties. Individually, such functional silicones are generally not reactive; however, together they form a reactive silicone system. Additionally, silicate resins (tackifiers) and PDMS with multiple hydrogen functionalities (crosslinkers) can be formulated to modify the adhesive properties of the gel.

The silicone gel adhesives resulting from the addition cure reaction are very lightly cross-linked polydimethysiloxane (PDMS) networks with some level of free (not cross-linked) PDMS fluid and little or no tackifiying resin. By contrast, tackifying resins are typically used at high levels (45-60 pph) in silicone PSAs.

In addition to the catalyst-promoted curing of silicone materials, it is known that free radicals formed from the high temperature degradation of organic peroxides can crosslink or cure silicone PSA formulations. This curing technique is undesirable due to the acidic residues left in the film from the curing chemistry, which are corrosive and unsuitable for skin contact.

Generally, the cross-linked siloxane networks of the present disclosure can be formed from either functional or non-functional silicone materials. These gel adhesives have excellent wetting characteristics, due to the very low glass transition temperature (Tg) and modulus of the polysiloxane network. Rheologically, these gels exhibit nearly identical storage moduli at bond making and bond breaking time scales, resulting in relatively low to moderate forces being required to debond the adhesive by peeling. This results in minimal to no skin trauma upon removal. Additionally, the elastic nature of the cross-linked gel prevents flow of the adhesive around hair during skin wear, further reducing the instances of pain during removal.

Generally, the silicone materials may be oils, fluids, gums, elastomers, or resins, e.g., friable solid resins. Generally, lower molecular weight, lower viscosity materials are referred to as fluids or oils, while higher molecular weight, higher viscosity materials are referred to as gums; however, there is no sharp distinction between these terms. Elastomers and resins have even higher molecular weights that gums, and typically do not flow. As used herein, the terms “fluid” and “oil” refer to materials having a dynamic viscosity at 25° C. of no greater than 1,000,000 mPa·sec (e.g., less than 600,000 mPa·sec), while materials having a dynamic viscosity at 25° C. of greater than 1,000,000 mPa·sec (e.g., at least 10,000,000 mPa·sec) are referred to as “gums”.

Generally, the silicone materials useful in the present disclosure are poly diorganosiloxanes, i.e., materials comprising a polysiloxane backbone. In some embodiments, the nonfunctionalized silicone materials can be a linear material described by the following formula illustrating a siloxane backbone with aliphatic and/or aromatic substituents:

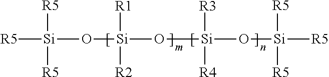

wherein R1, R2, R3, and R4 are independently selected from the group consisting of an alkyl group and an aryl group, each R5 is an alkyl group and n and m are integers, and at least one of m or n is not zero. In some embodiments, one or more of the alkyl or aryl groups may contain a halogen substituent, e.g., fluorine. For example, in some embodiments, one or more of the alkyl groups may be —CH₂CH₂C₄F₉.

In some embodiments, R5 is a methyl group, i.e., the nonfunctionalized poly diorganosiloxane material is terminated by trimethylsiloxy groups. In some embodiments, R1 and R2 are alkyl groups and n is zero, i.e., the material is a poly(dialkylsiloxane). In some embodiments, the alkyl group is a methyl group, i.e., poly(dimethylsiloxane) (“PDMS”). In some embodiments, R1 is an alkyl group, R2 is an aryl group, and n is zero, i.e., the material is a poly(alkylarylsiloxane). In some embodiments, R1 is methyl group and R2 is a phenyl group, i.e., the material is poly(methylphenylsiloxane). In some embodiments, R1 and R2 are alkyl groups and R3 and R4 are aryl groups, i.e., the material is a poly(dialkyldiarylsiloxane). In some embodiments, R1 and R2 are methyl groups, and R3 and R4 are phenyl groups, i.e., the material is poly(dimethyldiphenylsiloxane).

In some embodiments, the nonfunctionalized poly diorganosiloxane materials may be branched. For example, one or more of the R1, R2, R3, and/or R4 groups may be a linear or branched siloxane with alkyl or aryl (including halogenated alkyl or aryl) substituents and terminal R5 groups.

As used herein, “nonfunctional groups” are either alkyl or aryl groups consisting of carbon, hydrogen, and in some embodiments, halogen (e.g., fluorine) atoms. As used herein, a “nonfunctionalized poly diorganosiloxane material” is one in which the R1, R2, R3, R4, and R5 groups are nonfunctional groups.

Generally, functional silicone systems include specific reactive groups attached to the polysiloxane backbone of the starting material (for example, hydrogen, hydroxyl, vinyl, allyl, or acrylic groups). As used herein, a “functionalized poly diorganosiloxane material” is one in which at least one of the R-groups of the following formula is a functional group:

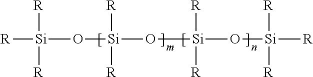

In some embodiments, a functional poly diorganosiloxane material is one is which at least 2 of the R-groups are functional groups. Generally, the R-groups may be independently selected. In some embodiments, at least one functional group is selected from the group consisting of a hydride group, a hydroxy group, an alkoxy group, a vinyl group, an epoxy group, and an acrylate group.

In addition to functional R-groups, the R-groups may be nonfunctional groups, e.g., alkyl or aryl groups, including halogenated (e.g., fluorinated) alky and aryl groups. In some embodiments, the functionalized poly diorganosiloxane materials may be branched. For example, one or more of the R groups may be a linear or branched siloxane with functional and/or non-functional substituents.

The gentle to skin adhesives of the present disclosure may be prepared by combining one or more poly diorganosiloxane materials (e.g., silicone oils or fluids), optionally with an appropriate tackifying resin, coating the resulting combination, and curing using electron beam (E-beam) or gamma irradiation. Generally, any known additives useful in the formulation of adhesives may also be included.

If included, generally, any known tackifying resin may be used, e.g., in some embodiments, silicate tackifying resins may be used. In some exemplary adhesive compositions, a plurality of silicate tackifying resins can be used to achieve desired performance.

Suitable silicate tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary silicate resins include MQ silicate tackifying resins, MQD silicate tackifying resins, and MQT silicate tackifying resins. These silicate tackifying resins usually have a number average molecular weight in the range of 100 to 50,000 gm/mole, e.g., 500 to 15,000 gm/mole and generally R′ groups are methyl groups.

MQ silicate tackifying resins are copolymeric resins where each M unit is bonded to a Q unit, and each Q unit is bonded to at least one other Q unit. Some of the Q units are bonded to only other Q units. However, some Q units are bonded to hydroxyl radicals resulting in HOSiO_{3/2} units (i.e., “T^{OH}” units), thereby accounting for some silicon-bonded hydroxyl content of the silicate tackifying resin.

The level of silicon bonded hydroxyl groups (i.e., silanol) on the MQ resin may be reduced to no greater than 1.5 weight percent, no greater than 1.2 weight percent, no greater than 1.0 weight percent, or no greater than 0.8 weight percent based on the weight of the silicate tackifying resin. This may be accomplished, for example, by reacting hexamethyldisilazane with the silicate tackifying resin. Such a reaction may be catalyzed, for example, with trifluoroacetic acid. Alternatively, trimethylchlorosilane or trimethylsilylacetamide may be reacted with the silicate tackifying resin, a catalyst not being necessary in this case.

MQD silicone tackifying resins are terpolymers having M, Q and D units. In some embodiments, some of the methyl R′ groups of the D units can be replaced with vinyl (CH2=CH—) groups (“D^{Vi}” units). MQT silicate tackifying resins are terpolymers having M, Q and T units.

Suitable silicate tackifying resins are commercially available from sources such as Dow Corning (e.g., DC2-7066), Momentive Performance Materials (e.g., SR545 and SR1000), and Wacker Chemie AG (e.g., BELSIL TMS-803).

The polysiloxane material, the tackifying resin, if present, and any optional additives may be combined by any of a wide variety of known means prior to being coated and cured. For example, in some embodiments, the various components may be pre-blended using common equipment such as mixers, blenders, mills, extruders, and the like.

In some embodiments, the materials may be dissolved in a solvent, coated, and dried prior to curing. In some embodiments, solventless compounding and coating processes may be used. In some embodiments, solventless coating may occur at about room temperature. For example, in some embodiments, the materials may have kinematic viscosity of no greater than 100,000 centistokes (cSt), e.g., no greater than 50,000 cSt. However, in some embodiments, hot melt coating processes such as extrusion may be used, e.g., to reduce the viscosity of higher molecular weight materials to values more suitable for coating. The various components may be added together, in various combinations or individually, through one or more separate ports of an extruder, blended (e.g., melt mixed) within the extruder, and extruded to form the hot melt coated composition.

Regardless of how it is formed, the coated compositions are radiation cured. In some embodiments, coating may be cured through exposure to E-beam irradiation. In some embodiments, the coating may be cured through exposure to gamma irradiation. In some embodiments, a combination of electron beam curing and gamma ray curing may be used. For example, in some embodiments, the coating may be partially cured by exposure to electron beam irradiation. Subsequently, the coating may be further cured by gamma irradiation.

A variety of procedures for E-beam and gamma ray curing are well-known. The cure depends on the specific equipment used, and those skilled in the art can define a dose calibration model for the specific equipment, geometry, and line speed, as well as other well understood process parameters.

Commercially available electron beam generating equipment is readily available. For the examples described herein, the radiation processing was performed on a Model CB-300 electron beam generating apparatus (available from Energy Sciences, Inc. (Wilmington, Mass.). Generally, a support film (e.g., polyester terephthalate support film) runs through a chamber. In some embodiments, a sample of uncured material with a liner (e.g., a fluorosilicone release liner) on both sides (“closed face”) may be attached to the support film and conveyed at a fixed speed of about 6.1 meters/min (20 feet/min). In some embodiments, a sample of the uncured material may be applied to one liner, with no liner on the opposite surface (“open face”). Generally, the chamber is inerted (e.g., the oxygen-containing room air is replaced with an inert gas, e.g., nitrogen) while the samples are e-beam cured, particularly when open-face curing.

The uncured material may be exposed to E-beam irradiation from one side through the release liner. For making a single layer laminating adhesive type tape, a single pass through the electron beam may be sufficient. Thicker samples, may exhibit a cure gradient through the cross section of the adhesive so that it may be desirable to expose the uncured material to electron beam radiation from both sides.

Commercially available gamma irradiation equipment includes equipment often used for gamma irradiation sterilization of products for medical applications. In some embodiments, such equipment may be used to cure, or partially cure the gentle to skin adhesives of the present disclosure. In some embodiments, such curing may occur simultaneously with a sterilization process for a semi-finished or finished product, for example a tape or wound dressing.

In some embodiments, the gentle to skin adhesives of the present disclosure are suitable for forming medical articles such as tapes, wound dressings, surgical drapes, IV site dressings, a prosthesis, an ostomy or stoma pouch, a buccal patch, or a transdermal patch. In some embodiments, the adhesives may also be useful for other medical articles including dentures and hairpieces.

In some embodiments, the adhesives may include any of a variety of known fillers and additives including, but not limited to, tackifiers (e.g., MQ resins), fillers pigments, additives for improving adhesion, additives for improving moisture-vapor transmission rate, pharmaceutical agents, cosmetic agents, natural extracts, silicone waxes, silicone polyethers, hydrophilic polymers and rheology modifiers. Additives used to improve adhesion, particularly to wet surfaces, include polymers such as poly(ethylene oxide) polymers, poly(propylene oxide) polymers and copolymers of poly(ethylene oxide and propylene oxide), acrylic acid polymers, hydroxyethyl cellulose polymers, silicone polyether copolymers, such as copolymers of poly(ethylene oxide) and polydiorganosiloxane and copolymers of poly(propylene oxide) and polydiorganosiloxane, and blends thereof.

In some embodiments, the gentle to skin adhesives of the present disclosure are suitable for adhering a medical substrate to a biological substrate (e.g., a human or an animal). For example, in some embodiments, the gentle to skin adhesives of the present disclosure may be used to adhere medical substrates to the skin of humans and/or animals.

Exemplary medical substrates include polymeric materials, plastics, natural macromolecular materials (e.g., collagen, wood, cork, and leather), paper, woven cloth and non-woven cloth, metals, glass, ceramics, and composites.

The thickness of the adhesive layer is not particularly limited. In some embodiments, the thickness will be at least 10 microns, and in some embodiments, at least 20 microns. In some embodiments, the thickness will be no greater than 400 microns, and in some embodiments, no greater than 200 microns.

The peel adhesion to biological substrates such as human skin is known to be highly variable. Skin type, location on the body, and other factors can affect results. Generally, average values of peel adhesion from skin are subject to large standard deviations. In some embodiments, the average peel adhesion for human skin may be less than 200 gm/2.54 cm, and in some embodiments, less than 100 gm/2.54 cm.

The operation of the present disclosure will be further described with regard to the following non-limiting detailed examples. These examples are offered to further illustrate the various specific and preferred embodiments and techniques. It should be understood, however, that many variations and modifications may be made while remaining within the scope of the present disclosure.

### EXAMPLES

### Summary of Materials

Unless otherwise noted, all parts, percentages, ratios, etc. in the Examples and the rest of the specification are by weight. In addition, Table 1 provides abbreviations and a source for all materials used in the Examples below:

TABLE 1

| Abbreviation | Description | Source |
|---|---|---|
| SiMac | Methacryloxy polydimethyl | Shin-Etsu Chemical Co, |
| | silicone macromer | Tokyo, Japan |
| | (M_{W} 1000-12,000) | |
| KF-2001 | Mercapto-functional | Shin-Etsu Chemical Co, |
| | silicone macromer | Tokyo, Japan |
| | (M_{W} 1000-15,000) | |
| AN | Acrylonitrile | Sterling Chemicals, |
| | | Houston, TX |
| MA | Methyl acrylate | Arkema Inc., Philadelphia, |
| | | PA |
| AA | Acrylic acid | Arkema Inc., Philadelphia, |
| | | PA |
| ODA | Octadecyl acrylate | San Esters Corp., Kowa, |
| | | Japan |
| ODMA | Octadecyl methacrylate | San Esters Corp., Kowa, |
| | | Japan |
| VAZO 67 | 2.2′-Azo bis | DuPont, Wilimington, DE |
| | (2-methylbutyronitrile) | |

### Test Methods

### Peel and Re-Adhesion Test Methods

The test method used to evaluate release coated substrates (non-woven and PET) was a modification of industry standard peel adhesion test used to evaluate PSA coated materials. The modified test method is described below. The reference source of the test method is ASTM D3330-78 PSTC-1 (1/75).

The peel force is a quantitative measure of the force required to remove a flexible adhesive tape from a substrate coated with the release coating of the invention at a specific angle and rate of removal. The force is expressed in g/cm (oz/in).

A 5% solids solution of low adhesion backsize (LAB) polymer of the invention in ethyl acetate was coated onto 2 mil Mitsubishi 3SAB PET (Mitusbishi Polyester Film, Inc., Greer, S.C.) and the uncoated portion of 3M POST-IT® Easel Pad paper (3M Company, St. Paul, Minn.) with #6 Meyer wire wound rod. The coated substrate was dried in a 65° C. oven for 30 minutes and conditioned for 1 hour at 22° C. and 50% relative humidity (CT/CH).

Strips (2.54 cm by 15.24 cm) of a MEPITAC® soft silicone dressing tape (Molnlycke Health Care, Norcross, Ga.) were adhered to the above coated sheets using a 0.91 kg (2 lb) roller. The peel testing was done by laminating a 2.54 cm by 20.32 cm strip of each composite to the stage of an Instromentors, Inc. slip/peel tester (Model 3M90) with double coated tape. The peel force required to remove the tape at a 180 degree angle and 228.6 cm/minute was then measured and reported as peel force in g/cm.

The freshly peeled test tape was re-adhered to a clean glass plate using 0.91 kg (2 lb) roller and the force required to remove the tape at a 180 degree angle and 228.6 cm/min was then measured and reported as re-adhesion to glass in g/cm.

### Examples of Low Adhesion Backsize (LAB) Compositions

### Example 1

### SiMac/AN/MA/ODA/AA, 36.3/20.75/34.75/6.64/1.56

A 750 milliliter amber jar was charged with 42.0 g SiMac, 24.0 g AN, 40.2 g MA, 12.0 g ODA (64% solids in ethyl acetate), 1.80 g AA, 180.0 g ethyl acetate and 0.60 g VAZO 67 (2,2′-Azo bis(2-methylbutyronitrile). The resulting solution was purged with N₂ at 1 liter per minute (LPM) for 5 minutes. The jar was sealed and tumbled in a 65° C. water bath for about 48 hr. After 48 hr, the jar was removed from hot water bath and cooled to room temperature. The percent solids of the copolymer were measured to be 36.4%. The resulting polymer solution was diluted to 5% solids with ethyl acetate. Modulated DSC of the polymer show T_{g}=51° C. and Tₘ=45° C.

### Example 2

### KF-2001/AN/MA/ODA/AA, 36.3/20.75/34.75/6.64/1.56

The procedure of Example 1 was repeated. The charges of components were as follows: 42.0 g KF-2001, 24.0 g AN, 40.2 g MA, 12.0 g ODA (64% solids in ethyl acetate), 1.80 g AA, 180 g ethyl acetate and 0.60 g VAZO 67. The percent solids of the copolymer were measured to be 36.9%. The resulting polymer solution was diluted to 5% solids with ethyl acetate.

### Example 3

### SiMac/AN/MA/ODA/AA, 36.3/18.75/34.75/8.64/1.56

The procedure of Example 1 was repeated. The charges of components were as follows: 43.6 g SiMac, 22.5 g AN, 41.70 g MA, 16.20 g ODA (64% solids in ethyl acetate), 1.87 g AA, 174.2 g ethyl acetate and 0.60 g VAZO 67. The percent solids were measured to be 38.6%. The resulting polymer solution was diluted to 5% solids in ethyl acetate.

### Example 4

### SiMac/AN/MA/ODA/AA, 36.3/22.75/34.75/4.64/1.56

The procedure of Example 1 was repeated. The charges of components were as follows: 43.56 g SiMac, 27.3 g AN, 41.7 g MA, 8.7 g ODA (64% solids in ethyl acetate), 1.87 g AA, 176.87 g ethyl acetate and 0.60 g VAZO 67. The percent solids were measured to be 38.6%. The resulting polymer solution was diluted to 5% solids in ethyl acetate.

### Example 5

### SiMac/AN/MA/ODA/AA, 36.3/25.25/25.75/11.14/1.56

The procedure of Example 1 was repeated. The charges of components were as follows: 43.56 g SiMac, 30.3 g AN, 30.9 g MA, 20.9 g (64% solids in ethyl acetate), 1.87 g AA, 172.5 g ethyl acetate and 0.60 VAZO 67. The percent solids were measured to be 39.1%. The resulting polymer solution was diluted to 5% solids in ethyl acetate. Modulated DSC of the polymer showed T_{g}=56° C. and Tₘ=50° C.

Example 5 LAB polymer was coated on PET and 3M Easel Pad Paper (available from 3M Company, St. Paul, Minn.) as described generally above. Peel and re-adhesion testing was conducted as described above. The results are shown in Tables 2 below.

TABLE 2

| | | | LAB Coated on 3M POST- | |
|---|---|---|---|---|
| | LAB Coated on PET | | IT ® Easel Pad Paper | |
| | Peel Force | Readhesion | Peel Force from | Readhesion |
| | from PET | to Glass | Easel Pad Paper | to Glass |
| Conditions | (g/cm) | (g/cm) | (g/cm) | (g/cm) |
| Aged for 3 | 3.57 | 72.5 | 27.45 | 58.03 |
| days at | | | | |
| CT/CH* | | | | |
| Aged for 3 | 3.79 | 67.0 | 10.27 | 56.92 |
| days at | | | | |
| 50° C. | | | | |
| Aged for 3 | 4.02 | 70.3 | 14.62 | 49.10 |
| days at | | | | |
| 65° C. | | | | |
| Aged for 1 | 4.02 | 50.2 | 7.25 | 63.61 |
| day at | | | | |
| 80° C. | | | | |
| Aged for 1 | 5.02 | 61.4 | 14.06 | 56.92 |
| day at | | | | |
| 100° C. | | | | |

*CT/CH is constant temperature of 22° C. and constant relative humidity of 50%

### Example 6

### SiMac/AN/MA/ODMA/AA, 36.3/20.75/34.75/6.64/1.56

The procedure of example 1 was repeated. The charges of components were as follows: 43.56 g SiMac, 24.90 g AN, 41.70 g MA, 7.97 g ODMA, 1.87 g AA, 180 g ethyl acetate and 0.60 g VAZO 67. % solids were measured to be 37.5%. The resulting polymer solution was diluted to 5% solids in ethyl acetate.

### Example 7

### SiMac/AN/MA/ODMA/AA, 36.3/25.25/25.75/11.14/1.56

The procedure of example 1 was repeated. The charges of components were as follows: 43.56 g SiMac. 30.30 g AN, 30.90 g MA, 13.37 g ODMA, 1.87 g AA, 180 g ethyl acetate and 0.60 g VAZO 67. % solids were measured to be 37.2%. The resulting polymer solution was diluted to 5% solids in ethyl acetate.

Low adhesion backsize compositions as described in the Examples are particularly useful when applied to a major surface of a backing or substrate to form an LAB on the substrate, and applying a PSA, preferably a silicone PSA, to the major surface of the substrate opposite the LAB. Suitable silicone PSA compositions and methods of making such silicone PSA-coated adhesive tape articles are described in PCT International Pub. No. WO 2010/056544.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A LAB composition comprising a silicone macromer co-polymerized with a crystalline (meth)acrylate monomer to form a copolymer, wherein the copolymer exhibits a glass transition temperature of from about −15° C. to about 55° C., and a crystalline melt transition of from about 25° C. to about 80° C.

2. The LAB composition of claim 1, wherein the glass transition temperature is at least about 25° C.

3. The LAB composition of claim 1, wherein the crystalline melt transition is at least about 50° C., optionally wherein the glass transition temperature is at least about 50° C.

4. The LAB composition of claim 1, wherein the silicone macromer is selected from:
a vinyl-functional silicone macromer having the general formula: 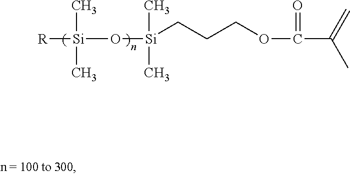
and R is H or an alkyl group;
a mercapto-functional silicone macromer having the general formula: 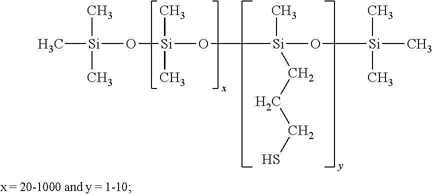
a mercapto-functional silicone macromer having the general formula: 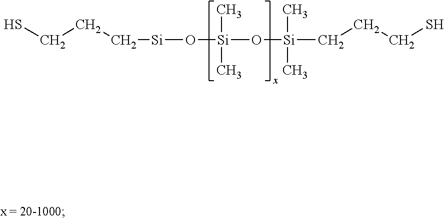
a mercapto-functional silicone macromer having the general formula: 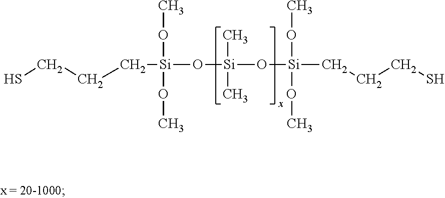
or a combination thereof.

5. The LAB composition of claim 1, wherein the crystalline (meth)acrylate monomer is a C₁₂-C₂₄ alkyl ester of (meth)acrylic acid.

6-8. (canceled)

9. The LAB composition of claim 1, substantially free of any organic solvent.

10. The LAB composition of claim 1, wherein the copolymer further comprises at least one polar monomer copolymerized with the silicone macromer and the crystalline (meth)acrylate monomer, wherein the at least one polar monomer is selected from acrylonitrile, methyl acrlyate, acrylic acid, methacrylic acid, hydroxyethylmethacrylate, hydroxpropylacrylate, and combinations thereof.

11-12. (canceled)

13. The LAB composition of claim 1, wherein the weight average molecular weight of the copolymer is at least about 15 kDa.

14. An article comprising the LAB composition of claim 1 applied to a first major surface of a substrate.

15. The article of claim 14, further comprising a silicone adhesive applied to a second major surface of the substrate opposite the LAB composition.

16. The article of claim 14, wherein the substrate is selected from a polymeric film, paper, woven cloth, non-woven cloth, and a web comprised of non-woven polymeric fibers.

17. (canceled)

18. The article of claim 16, wherein the substrate is a polyethylene terephthalate (PET) film, further wherein the article exhibits a peel force of less than about 6 g/cm when the LAB composition is contacted with a second PET film, and a readhesion of less than about 73 g/cm when the LAB composition is subsequently contacted with glass.

19. The article of claim 16, wherein the substrate is paper, further wherein the article exhibits a peel force of less than about 28 g/cm when the LAB composition is contacted with paper, and a readhesion of less than about 64 g/cm when the LAB composition is subsequently contacted with glass.

20. The article of claim 14, wherein the article is a liner-less adhesive tape.

21. The article of claim 14, wherein the silicone adhesive comprises a radiation cured silicone gel, further wherein the silicone gel comprises a cross-linked polydiorganosiloxane material.

22. The article of claim 21, wherein the silicone adhesive is formed by exposing a composition comprising a polydiorganosiloxane material to at least one of electron beam irradiation and gamma irradiation at a sufficient dose to crosslink the polydiorganosiloxane material.

23. The article of claim 21, wherein the polydiorganosiloxane material comprises a polydimethylsiloxane, optionally wherein the polydimethylsiloxane is selected from the group consisting of one or more silanol terminated polydimethylsiloxanes, one or more non-functional polydimethylsiloxanes, and combinations thereof.

24-25. (canceled)

26. The article of claim 21, wherein the silicone adhesive further comprises a silicate resin tackifier, a poly(dimethylsiloxane-oxamide) linear copolymer, or a combination thereof.

27. (canceled)

28. The article of claim 21, wherein the polydiorganosiloxane material comprises a polydiorganosiloxane fluid having a dynamic viscosity at 25° C. of no greater than 1,000,000 mPa·sec, optionally wherein the polydiorganosiloxane material consists of polydiorganosiloxane fluids having a kinematic viscosity at 25° C. of no greater than 100,000 centistokes.

29. (canceled)

30. The article of claim 21, wherein the silicone adhesive has a 180 degree peel adhesion from human skin of no greater than 200 grams per 2.54 centimeters as measured according to the Skin Peel Adhesion Procedure, optionally wherein the silicone adhesive has a thickness of 20 to 200 micrometers.

31-33. (canceled)
